(19) United States
(12) Patent Application Publication
(10) Pub. No.: US 2020/0171614 A1
(43) Pub. Date: Jun. 4, 2020

(54) Wet Box Work Station

(71) Applicant: Jesse Gionta, Wappingers Falls, NY (US)

(72) Inventor: Jesse Gionta, Wappingers Falls, NY (US)

(21) Appl. No.: 16/679,902

(22) Filed: Nov. 11, 2019

Related U.S. Application Data
(63) Continuation-in-part of application No. 16/204,026, filed on Nov. 29, 2018, now Pat. No. 10,471,585.

(51) Int. Cl. B23Q 11/08; B28D 7/02

(52) U.S. Cl. CPC B23Q 11/0891; B27B 5/29; B28D 7/02

(57) ABSTRACT

An enclosure for using a tile saw is described. The enclosure comprises a rectangular tray having a front, a rear, and two side walls and a bottom surface wherein the bottom surface is inclined from a first height adjacent to the front wall to a second height away form said front wall wherein the second height is lower with respect to top surfaces of the front, rear, and side walls than the first height wherein the tray is configured to have a tile saw used therein. Two side panels, a rear panel, and a top panel are configured to be joined together to form a waterproof box on three sides and top of the tray so that water used to cool a tile saw blade is not sprayed outside of the waterproof box.

### TECHNICAL FIELD

The disclosure relates to tile cutting, and more particularly, to a wet box work station that will improve the tile cutting process.

### BACKGROUND

Ceramic or porcelain tile is used as flooring or on walls or counters in residences and businesses. When installing tile, the installer must cut at least some of the tiles to fit the desired layout pattern. Wet saws are power tools that use a water-cooled diamond blade for cutting tile. Water helps the saw blade to cut cooler, faster, and longer. The usual practice is to cut tile outdoors since the process is messy because of sprayed water. This requires the installer constantly to move between outside and inside during installation. Cold, hot, or inclement weather of any kind results in more of a problem with this method.

Several U.S. Patents show tables or covers for tile saws, including U.S. Pat. No. 9,285,132 (Waulters), U.S. Pat. No. 8,215,296 (Cisneros), U.S. Pat. No. 6,557,602 (Sorenson et al), U.S. Pat. No. 5,557,955 (Voege), and U.S. Pat. No. 4,779,603 (Crocetti).

### SUMMARY

A principal object of the present disclosure is to provide an enclosure for operating a tile saw wherein water is prevented from spraying outside the enclosure.

Another object of the present disclosure is to provide an enclosure for operating a tile saw wherein water is prevented from spraying outside the enclosure so that tile can be cut in an interior setting.

A further object of the disclosure is to provide a wet box for a tile saw that can be used in an interior setting wherein removable legs allow the wet box to be set either on the legs or on a surface.

Yet another object is to provide a wet box for a tile saw wherein the wet box has a drain hole configured to receive a plug or a standard hose fitting.

In accordance with the objects of the disclosure, an enclosure for using a tile saw is achieved. The enclosure comprises a rectangular tray having a front, a rear, and two side walls and a bottom surface wherein the bottom surface is inclined from a first height adjacent to the front wall to a second height adjacent to the rear wall wherein the second height is lower with respect to top surfaces of the front, rear, and side walls than the first height wherein the tray is configured to have a tile saw used therein. Two side panels, a rear panel, and a top panel are configured to be joined together to form a waterproof box on three sides and top of the tray so that water used to cool a tile saw blade is not sprayed outside of the waterproof box.

Also in accordance with the objects of the disclosure, a method for cutting tile is achieved. An enclosure is provided comprising a rectangular tray having a front, a rear, and two side walls and a bottom surface wherein the bottom surface is inclined from a first height adjacent to the front wall to a second height adjacent to the rear wall wherein the second height is lower with respect to top surfaces of the front, rear, and side walls than the first height. Two side panels, a rear panel, and a top panel are configured to be joined together to form a waterproof box on three sides and top of the tray. Tile is cut using a tile wet saw within the enclosure wherein water spray from the tile wet saw remains within the enclosure.

Also in accordance with the objects of the disclosure, a method for cutting tile is achieved. An enclosure is provided comprising a rectangular tray having a front, a rear, and two side walls and a bottom surface wherein the bottom surface is inclined from a first height adjacent to the front wall to a second height adjacent to the rear wall wherein the second height is lower with respect to top surfaces of the front, rear, and side walls than the first height and a first lip extending an entire length of the rear and side walls along an outside surface of the rear and side walls and at least one first slot in a top surface of the walls abutting the first lip. Two side panels comprise at least one tab on a bottom edge of each of the side panels, a second lip on a rear edge of each of the side panels, at least one second slot on the second lip, the second slot having a round portion and a vertical slot portion under and connected with the round portion; and at least one third slot on top edges of each of the side panels wherein the third slots each have a first vertical component extending from the top edge of the side panel downward to a first end of a horizontal component and a second vertical component extending downward from a second end of the horizontal component.

A rear panel comprises at least one tab on a bottom edge thereof and at least one first button on each side of a front surface of the rear panel aligned with each second slot. A top panel comprises a third lip extending around three sides of the top panel and at least one second button on an inside of the third lip adjacent to each of the side panels. At least one tab of each of the two side panels is inserted into the side wall first slots. Thereafter, at least one second button on each side of the rear panel is inserted into the round portion of the second slot on the second lip and the buttons are slid down the vertical slot while the at least one tab on the bottom edge of the rear panel is inserted into the first slot in the rear wall thereby locking in place the side and rear panels. The top panel is placed on top of the locked in place side and rear panels wherein the third lip abuts outside surfaces of the side and rear panels. The at least one second button on the inside of the third lip adjacent to each of the side panels is slid into the first vertical slot, then along the horizontal slot, and finally into the second vertical slot to lock the top panel into place, thereby providing a waterproof box. Tile is cut using a tile wet saw inside the enclosure wherein water used to cool a blade of the tile wet saw is not sprayed outside of the waterproof box.

Also in accordance with the objects of the disclosure, an enclosure for using a tile saw is achieved. The enclosure comprises a rectangular tray having a front, a rear, and two side walls and a bottom surface wherein the bottom surface is inclined from a first height adjacent to the front wall to a second height away from the front wall wherein the second height is lower with respect to top surfaces of the front, rear, and side walls than the first height wherein the tray is configured to have a tile saw used therein. Two side panels, a rear panel, and a top panel are configured to be joined together to form a waterproof box on three sides and top of the tray so that water used to cool a tile saw blade is not sprayed outside of the waterproof box. At least two rails in the tray run in parallel from a first side wall to a second side wall or run in parallel from the rear wall to the front wall and are configured to facilitate sliding a tile saw from one side of the tray to another side of the tray, from front to back of the tray, or diagonally on the rails.

Also in accordance with the objects of the disclosure, a method for cutting tile is achieved. An enclosed work station is provided comprising a rectangular tray having a front, a rear, and two side walls and a bottom surface wherein the bottom surface is inclined from a first height adjacent to the front wall to a second height away from the front wall wherein the second height is lower with respect to top surfaces of the front, rear, and side walls than the first height, two side panels, a rear panel, and a top panel configured to be joined together to form a waterproof box on three sides and top of the tray, and at least two rails in the tray running in parallel from a first side wall to a second side wall or running in parallel from the rear wall to the front wall and configured to facilitate sliding a tile saw from one side of the tray to another side of the tray, from front to back of the tray, or diagonally on the rails. Tile is cut using a tile wet saw within the enclosed work station wherein water spray from the tile wet saw remains within the enclosed work station.

### BRIEF DESCRIPTION OF THE DRAWINGS

In the accompanying drawings forming a material part of this description, there is shown:

FIG. 1 is an isometric view of a preferred embodiment of the present disclosure.

FIG. 2 is an isometric view of a portion of the preferred embodiment of the present disclosure.

FIG. 3 is an exploded view of the preferred embodiment of the present disclosure.

FIG. 4 is an enlarged isometric view showing top edges of side portions of the preferred embodiment of the present disclosure.

FIG. 5 is an enlarged isometric view showing the underside of a top portion of the preferred embodiment of the present disclosure.

FIG. 6 is a rear view of the preferred embodiment of the present disclosure.

FIG. 7 is an isometric view of a second preferred embodiment of the present disclosure.

FIG. 8 is an isometric view of a portion of the second preferred embodiment of the present disclosure.

FIG. 9 is an exploded view of another preferred embodiment of the present disclosure.

### DETAILED DESCRIPTION

The present disclosure describes an enclosure or box for cutting tile, for example, ceramic or porcelain tile such as used in kitchens or bathrooms, using a wet saw. Additionally, other materials can be cut using the wet box of the present disclosure, including marble, stone, and brick, for example. The box is waterproof and used to contain the tile wet saw and to avoid unwanted water spray from leaving the box.

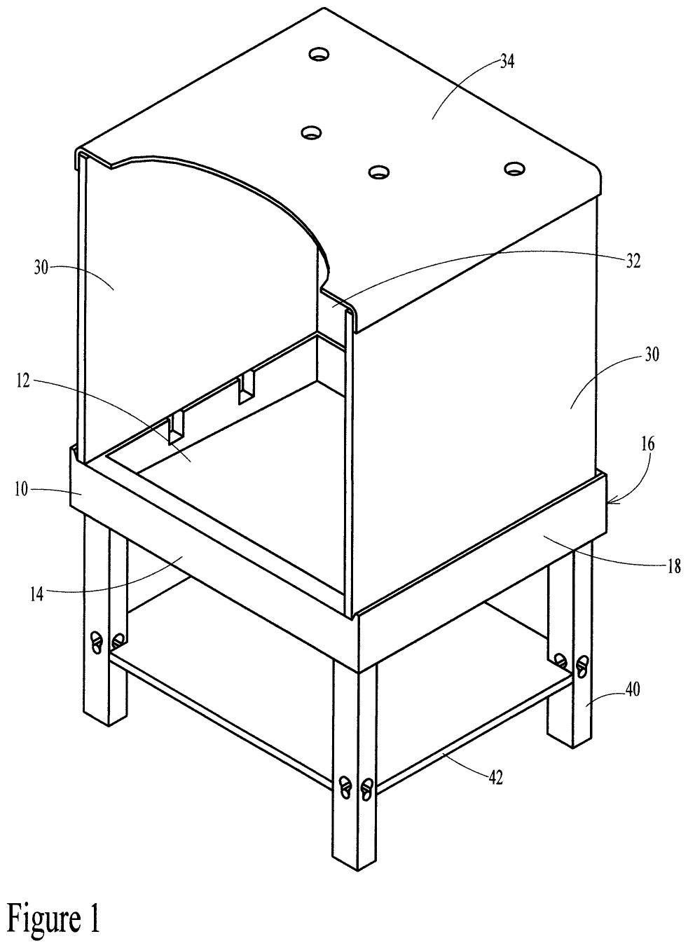

Referring now to the drawing figures, the wet box of the present disclosure will be described in detail. FIG. 1 illustrates a preferred embodiment of the wet box of the present disclosure. Tray 10 is preferably constructed of one piece of molded plastic. The front 14, rear 16, and side 18 portions of the tray 10 are level; that is, they are on a same plane. The floor 12 of the tray is pitched so that it angles from a high point at the front 14 of the box at which the tile saw user will be standing to a low point at the rear 16 of the box. For example, a height difference between the front 14 height of the floor 12 and the rear 16 height of the floor 12 is between about 1.5 and 3 inches, and preferably about 2″. A wet saw will be rested on the front panel 14.

Two side panels 30, rear panel 32, and top panel 34 connect together to form three-sided protection from water spray when the tile saw is in use. These four panels will snap, slide, and/or lock together. Removable legs 40 and bottom shelf 42 are also shown.

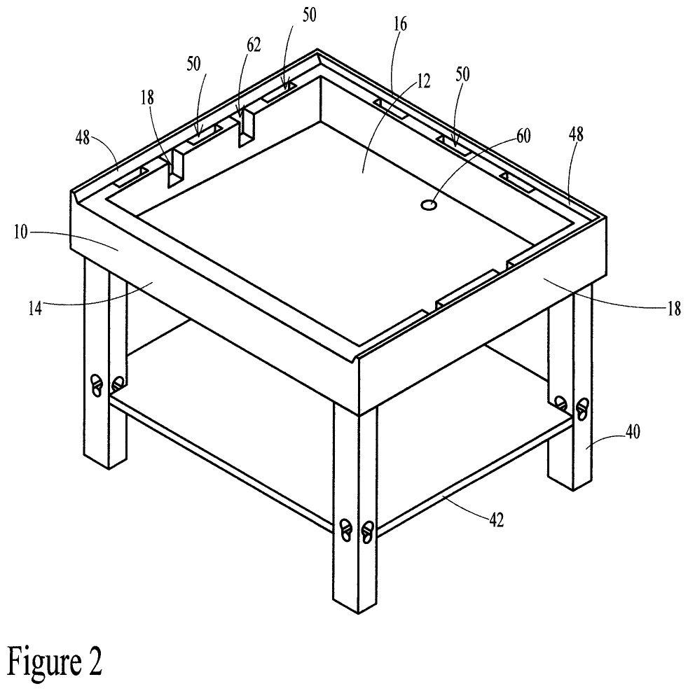

FIG. 2 illustrates the wet box with side, rear, and top panels removed. Lip 48 extends above the side and rear walls 18 and 16 of the tray 10. Slots 50 can be seen formed in a portion of the side and rear walls abutting the lip.

Also visible in FIG. 2 is drain hole 60. The drain hole is threaded to accept a standard garden hose or washing machine hose, for example, for the purpose of draining or cleaning the tray. For example, a hose can be threaded into the drain hole so that any water in the tray will drain out through the hose, perhaps into a bucket placed on the shelf 42, or into a drain near the wet box. Water could drain directly into a bucket or container below the tray through the drain hole without the use of a hose. Alternately, the drain hole can be plugged so that water does not drain out of the tray. A plug can be threaded or inserted snugly into the drain hole. Often, excess spray is minimal and can be sponged up from the tray rather than needing a hose and bucket.

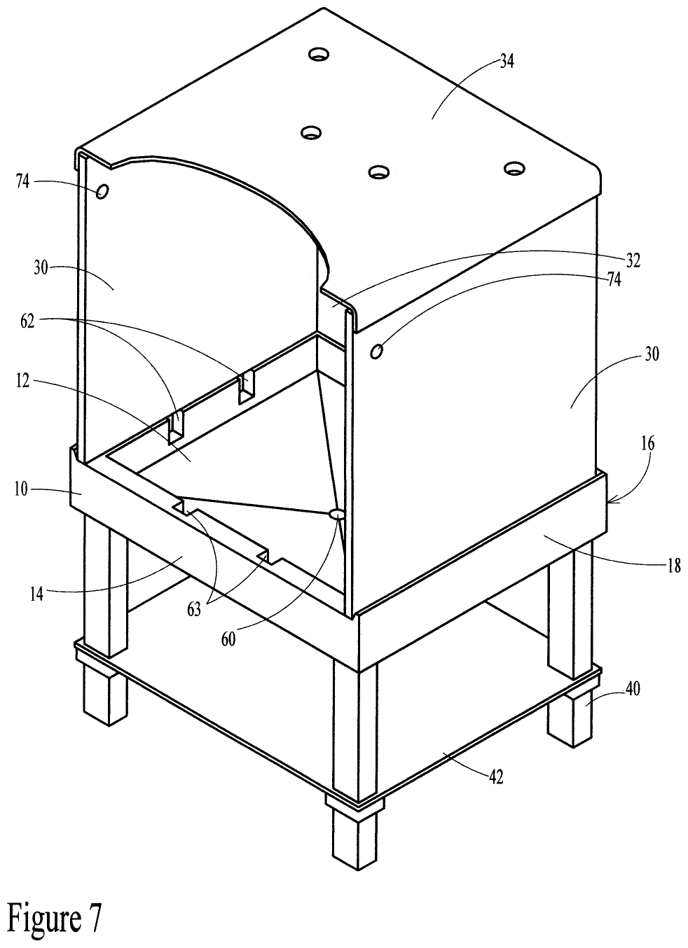

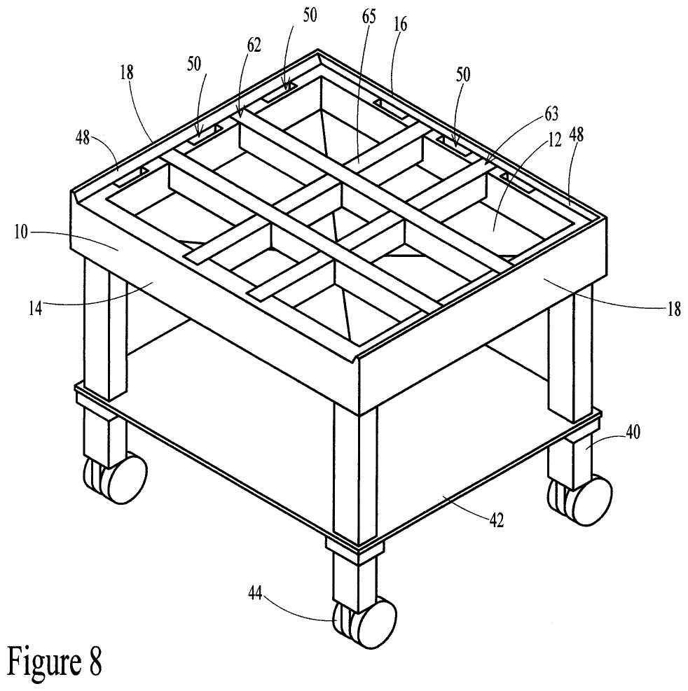

Referring to FIGS. 7 and 8, in a second preferred embodiment of the present disclosure, the floor 12 of the tray is pitched from high points at both the front and the back and at the sidewalls to a low point in the center of the tray. A center drain hole 60 is shown in FIG. 7. Alternatively, as shown in FIG. 8, there is a center low point, but no center drain. This is useful where excess spray is minimal and can be sponged up from the tray. Or, a drain can be added as an option.

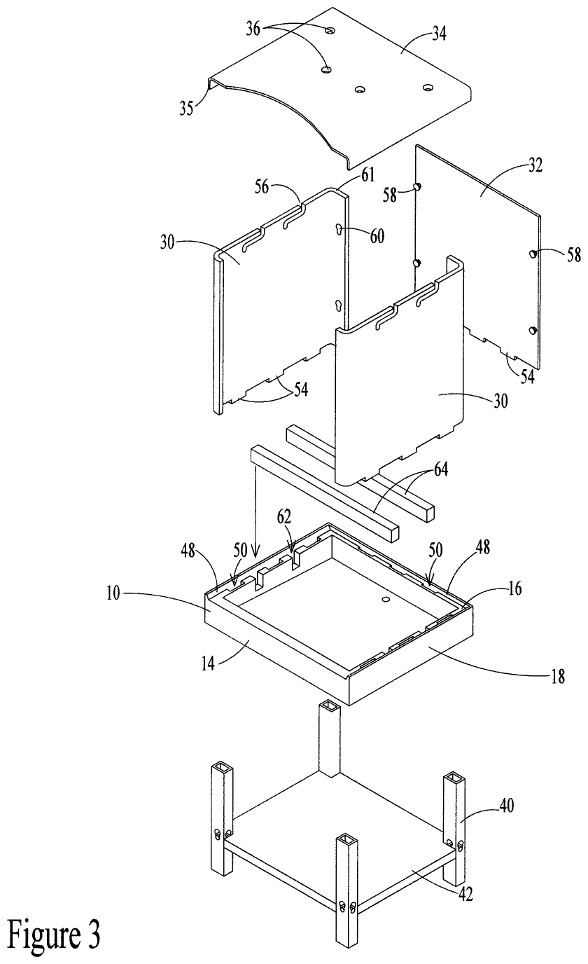

FIG. 3 is an exploded view of one embodiment of the wet box of the present disclosure showing parts of the wet box that can be disassembled by a user of the box. Side and rear panels, 30 and 32, respectively, have tabs 54 on their bottom edges that fit into slots 50 on the tray, shown in FIG. 2. The lip 48 abuts the outside surface of the side and rear panels when they are installed.

Each side panel 30 has a lip 61 on the rear edge of the panel. At least one slot 60 is on the lip having a round portion and a vertical slot portion under and connected with the round portion. At least one button is on each side of the rear surface of the rear panel 32 aligned with each slot 60. Note that the rear surface of the rear panel is shown in FIG. 3. When it is installed, it will be flipped around.

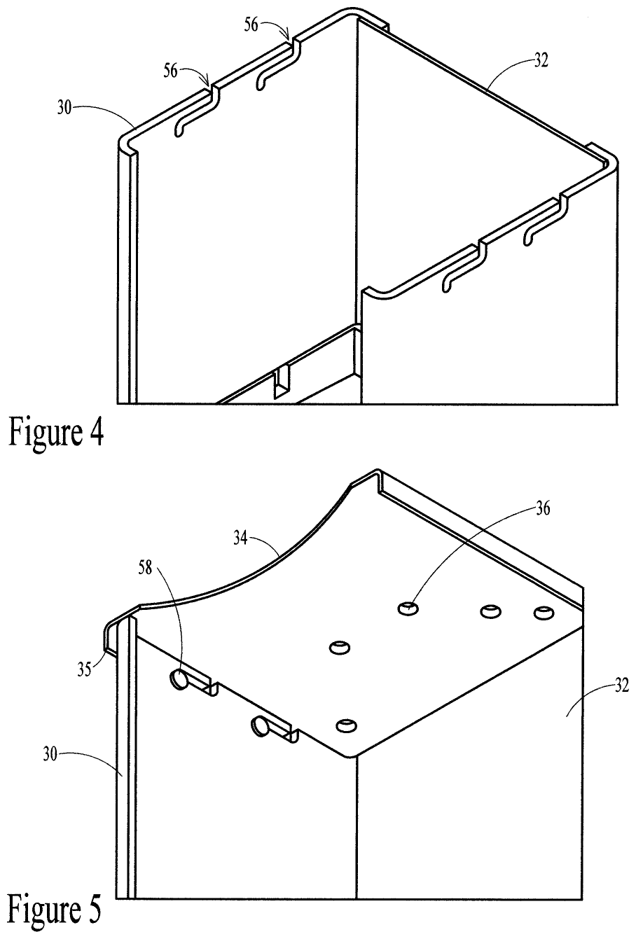

After the two side panels have been installed in the slots 50, buttons 58 on the outside surface of the rear panel 32 are inserted into the round portion of slot 60 on lip 61 at the rear edge of the side panels 30. As the rear panel is slid into the rear slot 50, the buttons 58 slide down the vertical slot. The side and rear panels are thus locked in place in a watertight configuration with the rear panel to the inside of the lip 61, as shown in FIG. 4.

FIGS. 4 and 5 illustrate how the top panel 34 locks onto the side and rear panels 30 and 32, respectively. FIG. 4 illustrates slots 56 on the top edges of the side panels 30. The slots each have a first vertical component extending from the top edge of the side panel downward to a first end of a horizontal component and a second vertical component extending downward from a second end of the horizontal component. As shown in FIG. 5, the top panel 34 has a lip 35 extending around three sides of the panel that, when the top panel is placed on top of the installed side and rear panels, abuts the outside surface of the side and rear panels. At least one button 58 on the inside of the lip adjacent to the side panels slides into the first vertical slot, then along the horizontal slot, and into the second vertical slot to lock the top panel into place, providing a waterproof seal.

The wet box can be used with the legs 40 in place under the tray 10. Preferably, four legs 40 supported by shelf 42 fit into indentations in the four corners of the underside of the tray 10. The legs are removable, however, so that the tray can be placed in alternate locations, such as on a kitchen or bathroom countertop or straddling a bathtub edge in a bathroom. Optionally, instead of shelf 42, there may be a frame connecting each of legs 40 to adjacent legs. As shown in FIG. 8, wheels 44 may be added to the legs.

Holes 36 on the top surface of the top panel 34 can be used for passing through the electrical cord of the wet saw or allowing for a drop light to be added, for example.

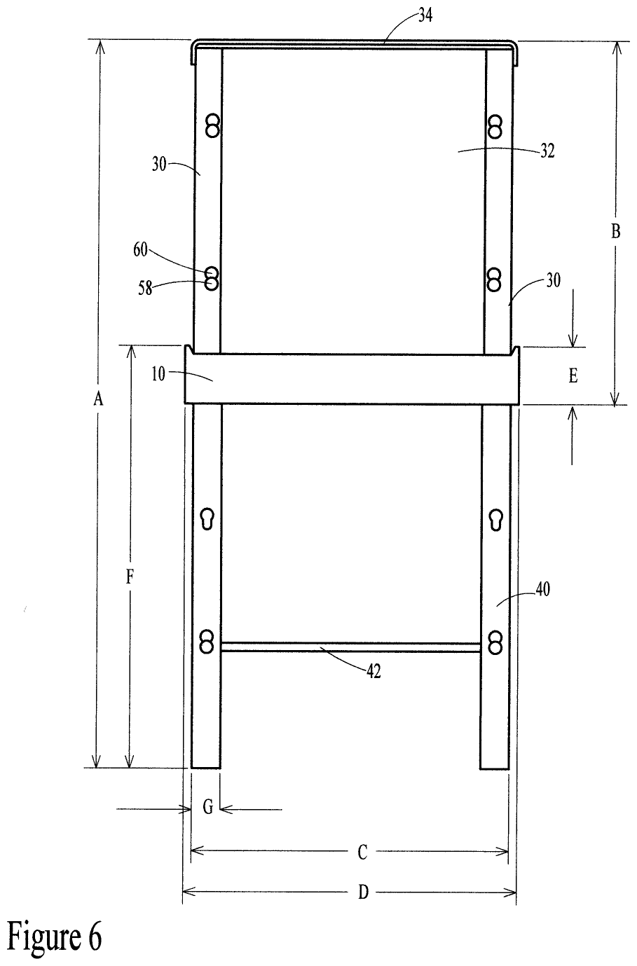

FIG. 6 illustrates a rear view of the wet box of the present disclosure. For example, the total height A of the wet box including the legs and protective panels is between about 55″ and 75″ and preferably about 64 inches. Height B is the measurement of the bottom of the tray 10 to the top of the top panel 34. This is between about 36″ and 50″ and preferably about 40 inches. The side-to-side measurement C of the outside surfaces of the legs 40 is between about 31 and 37 inches. The side-to-side measurement D of the tray 10 is between about 34 and 40 inches. The height E of the tray walls is between about 4″ and 7″ and preferably about 6 inches. The height F from the floor to the top of the tray walls when the tray is on the legs is between about 28″ and 36″ and preferably about 30 inches. The thickness of the legs 40 is between about 2 and 3 inches.

A narrower wet box can be advantageous for cutting smaller tiles while a wider wet box can cut larger tiles. As shown in FIG. 3, unique dual rail supports are incorporated inside the wet box. The rails 64 are preferably made to the dimensions of standard 2x3 lumber. The rails are the length of the inside horizontal measurement of the tray 10 and slide into slots 62 in the tray sides 16. The rails 64 provide a stable surface for the wet saw and make it easier to slide the wet saw side-to-side and front-to-back. The wet saw can also be slid partially out of the box on the rails to allow for long rip cuts of long tile. The wet saw can even be set up diagonally on the rails to allow for making occasional crosscuts of long tile or marble saddles by allowing the tile to hang out of the box. The rails also allow for differences in the outer dimensions of the wet saw as there are variations in size according to the style and manufacturer of the wet saw.

As shown in FIGS. 7 and 8, rails 64 can be slid into slots 63 in the front and rear of the tray sides 16 instead of the side slots 62. Alternatively, rails 65 may be configured in a cross pattern similar to a tic tac toe board, as shown in FIG. 8, to accommodate different tile saw designs. Another option, as shown in FIG. 7, is a hole 74 drilled near the top front corner of the left and/or right side panels to provide for hanging a towel, for example. The corner of a towel could be poked into the hole for convenient access.

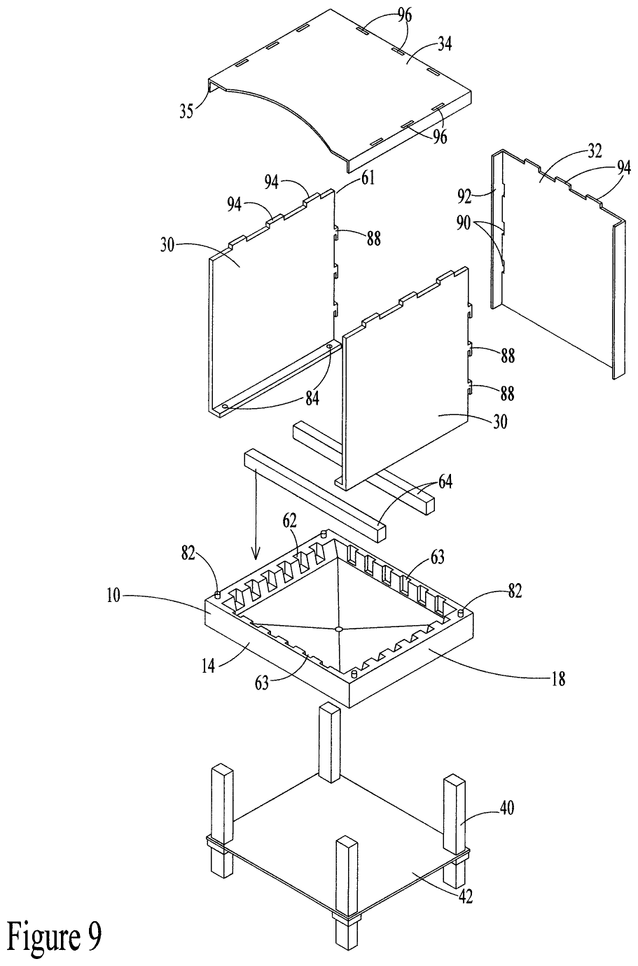

FIG. 9 is an exploded view of another embodiment of the wet box of the present disclosure showing parts of the wet box that can be disassembled by a user of the box. This figure shows a different locking together method for the wet box. It will be understood that a variety of methods and features for assembling the wet box may be used, so long as the side, rear, and top panels and the tray snap, slide, and/or lock together.

Side panels 30 have holes 84 on a bottom lip through which molded in pegs 86 on the base tray, for example, lock the side panels to the tray. Side panels 30 attach to rear panel 32 by hooking tabs 88 on the rear edges of the side panels through slots 90 on each side of the rear panel 32 (only the slots on one side are seen in this view). Alternatively, the rear panel could have locator holes that mate with pegs on the side panels, similar to the locator holes 84 on the bottom of the side panels and pegs on the tray. Preferably, rear panel 32 has a lip 92 on each side that will fit around the edge of each side panel 30 to provide an overlap.

Side and rear panels, 30 and 32, respectively, have tabs 94 on their top edges that fit into slots 96 on the top panel 34 having a lip 35 around the side and rear edges so as to stabilize the fully assembled unit and to form a watertight seal with the side and rear panels of the enclosure.

A plurality of slots 62 and 63 are provided in both sides and front and rear of the tray so that the rails 64 or cross patterned rails 65 can be configured in a variety of ways. Any of the features of any of the embodiments can be combined in any desired configuration.

The enclosure provides a complete work station for a user. The tray 10 provides a very convenient shelf. Side areas of the tray may be used as a wet space for storing still wet tile pieces for later use. The wet box work station effectively contains water used to cool the tile saw blade within the enclosure and prevents water spraying out of the enclosure during use of a wet saw. Thus, a user may use the work station of the present disclosure in an indoor setting; for example, in an upper floor of an apartment building, or in poor weather, without fear of damaging an indoor area. The enclosure of the present disclosure is primarily a secondary containment system, as normally wet saws have their own built-in water containment system. However, the instant enclosure may also be able to be used as a primary water supply tray with some model saws.

The wet box of the present disclosure can be used for a variety of different wet saw sizes and for cutting a variety of tile sizes. The wet box includes side, rear, and top panels that can be joined together to form a waterproof box on three sides and top of the tray so that water used to cool the saw blade is not sprayed outside of the box. This allows a tile installer to cut tile indoors without worrying about the mess. The wet box can be used on its legs or the tray may be placed directly on a countertop, for example.

Although the preferred embodiment of the present disclosure has been illustrated, and that form has been described in detail, it will be readily understood by those skilled in the art that various modifications may be made therein without departing from the spirit of the disclosure or from the scope of the appended claims.

What is claimed is:

1. An enclosure for using a tile saw comprising:
a rectangular tray having a front, a rear, and two side walls and a bottom surface wherein said bottom surface is inclined from a first height adjacent to said front wall to a second height away from said front wall wherein said second height is lower with respect to top surfaces of said front, rear, and side walls than said first height wherein said tray is configured to have a tile saw used therein; and
two side panels, a rear panel, and a top panel configured to be joined together to form a waterproof box on three sides and top of said tray so that water used to cool a tile saw blade is not sprayed outside of said waterproof box; and
at least two rails in said tray running in parallel from a first said side wall to a second said side wall or running in parallel from said rear wall to said front wall and configured to facilitate sliding a tile saw from one side of said tray to another side of said tray, from front to back of the tray, or diagonally on said rails.

2. The enclosure according to claim 1 wherein said tray comprises a single piece of molded plastic.

3. The enclosure according to claim 1 wherein said second height is adjacent to said rear wall.

4. The enclosure according to claim 1 wherein said second height is in a center of said tray.

5. The enclosure according to claim 1 further comprising a drain hole in said bottom surface of said tray at said second height.

6. The enclosure according to claim 5 wherein said drain hole is configured to receive:
a hose threaded therein to allow drainage of water through said drain hole; or
a drain plug threaded or snugly inserted therein to prevent drainage of water through said drain hole.

7. The enclosure according to claim 1 further comprising removable legs configured to support said tray thereon.

8. The enclosure according to claim 7 further comprising removable wheels on said removable legs.

9. The enclosure according to claim 1 wherein said at least two rails each have two ends configured to slide into first slots extending vertically downward from top edges of each of said side walls of said tray or into second slots extending vertically downward from top edges of each of said front and rear walls of said tray.

10. The enclosure according to claim 1 wherein said at least two rails in said tray run in parallel from a first said side wall to a second said side wall and further comprising at least two rails running in parallel from said rear wall to said front wall wherein said rails are arranged in a cross pattern.

11. The enclosure according to claim 1 further comprising at least one hole drilled into at least one of said side walls configured to allow a towel to be hung.

12. A method for cutting tile comprising:
providing an enclosed work station comprising:
a rectangular tray having a front, a rear, and two side walls and a bottom surface wherein said bottom surface is inclined from a first height adjacent to said front wall to a second height away from said front wall wherein said second height is lower with respect to top surfaces of said front, rear, and side walls than said first height;
two side panels, a rear panel, and a top panel configured to be joined together to form a waterproof box on three sides and top of said tray; and
at least two rails in said tray running in parallel from a first said side wall to a second said side wall or running in parallel from said rear wall to said front wall and configured to facilitate sliding a tile saw from one side of said tray to another side of said tray, from front to back of the tray, or diagonally on said rails; and
cutting said tile using a tile wet saw within said enclosed work station wherein water spray from said tile wet saw remains within said enclosed work station.

13. The method according to claim 12 wherein said tray comprises a single piece of molded plastic.

14. The method according to claim 12 wherein said tray further comprises a drain hole in said bottom surface of said tray at said second height and wherein said method further comprises:
threading a hose into said drain hole to allow drainage of water through said drain hole; or
placing a container underneath said drain hole to allow drainage of water through said drain hole into said container; or
threading or snugly inserting a drain plug into said drain hole to prevent drainage of water through said drain hole.

15. The method according to claim 12 further comprising:
adding removable legs at four corners of said tray to support said tray thereon; or
removing said removable legs from said four corners of said tray to support said tray on a surface.

16. The method according to claim 15 further comprising adding removable wheels on said removable legs.

17. The method according to claim 12 further comprising:
inserting each end of said at least two rails into first slots extending vertically downward from top edges of each of said side walls of said tray; or
inserting each end of said at least two rails into second slots extending vertically downward from top edges of each of said front wall and said rear wall of said tray.

18. The method according to claim 12 wherein at least four rails are arranged in a cross pattern of at least two first rails parallel in a horizontal direction and at least two second rails parallel in a vertical direction in a same plane and further comprising:
inserting each end of said at least two first rails into first slots extending vertically downward from top edges of each of said side walls of said tray; and
inserting each end of said at least two second rails into second slots extending vertically downward from top edges of each of said front wall and said rear wall of said tray.

19. The method according to claim 12 wherein said enclosure further comprises at least one hole in at least one of said side walls and further comprising:
hanging a towel through said at least one hole.
